(19) United States
(12) Patent Application Publication
(10) Pub. No.: US 2008/0018622 A1
(43) Pub. Date: Jan. 24, 2008

(54) Information inputting device and inputting method therefor

(75) Inventors: Eung-Cheon Kang, Hwaseong-si (KR); Wook-Hee Lee, Yongin-si (KR); Ho-Chul Joung, Yongin-si (KR); Bu-Whan Hyun, Suwon-si (KR); Gi-Lyong Na, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/826,664

(22) Filed: Jul. 17, 2007

(30) Foreign Application Priority Data
Jul. 18, 2006 (KR) 10-2006-0066880
May 15, 2007 (KR) 10-2007-0046990

(51) Int. Cl. G06F 3/033

(52) U.S. Cl. 345/184

(57) ABSTRACT

An information inputting device and inputting method therefor are disclosed. The information inputting device includes a case, a rotary inputting device which has a rotatable wheel and which is secured to the inside of the case, where the entire surface of the wheel is exposed to the exterior of the case and the rotary inputting device is capable of inputting information by means of the rotation of the wheel, an optical module secured to the inside of the case which recognizes the movement of the case, and a wire connected to an external device which transfers the information inputted by the rotary inputting device and the information recognized by the optical module to the external device. Information may be inputted using such an information inputting device by means of the rotation of the wheel. As the information inputting device has a small volume, it allows convenient portability.

### CROSS-REFERENCE TO RELATED APPLICATIONS

This application claims the benefit of Korean Patent Application No. 10-2006-0066880 filed with the Korean Intellectual Property Office on Jul. 18, 2006, and Korean Patent Application No. 10-2007-0046990 filed with the Korean Intellectual Property Office on May 15, 2007, the disclosure of which is incorporated herein by reference in its entirety.

### BACKGROUND

1. Technical Field

The present invention relates to an information inputting device and inputting method therefor.

2. Description of the Related Art

Information inputting devices, such as the mouse, are used as hardware for inputting information in such electronic apparatus as personal computers and notebooks, etc. In particular, with the use of Windows from Microsoft as the OS (operating system) in computers, the use of the mouse has spread rapidly as an inputting means other than the keyboard.

FIG. 1 is a perspective view of a mouse 100, as an example of a conventional inputting device.

Referring to FIG. 1, a conventional mouse has a main frame 110 having a flat bottom surface, a grip part 120 formed on the upper side of the main frame 110 to allow gripping by a hand, buttons 130 formed at the front of the grip part 120 to be pressed by a finger, etc., a sensor part formed on the lower side of the mainframe 110 that recognizes position changes of the mouse 100, and a cable 150 for connecting the mouse 100 to an electronic device such as a personal computer. Also, a wheel 160 is formed between the buttons 130.

A user moves the mouse 100 2-dimensionally on a mouse pad, to move a cursor, etc., to a desired position, and then clicks a button 130 to run a corresponding icon, etc. Also, to move the screen on the display of the computer up or down, the wheel 160 is rotated forward or backward with respect to the user.

However, as the conventional information inputting device has a convex shape for easy holding by the user, it is inevitably given a large volume. Also, since the wheel 160, one of the inputting means, is positioned perpendicularly to the work surface, such as the pad, there is a limit to how much the volume of the information inputting device can be reduced.

### SUMMARY

An aspect of the invention aims to provide an information inputting device and inputting method therefor, where the information inputting device has a small volume for convenient use and portability.

Another aspect of the invention aims to provide an information inputting device and inputting method therefor that allow convenient use, as the wire of the information inputting device is wound automatically.

One aspect of the invention provides an information inputting device which includes a case, a rotary inputting device which has a rotatable wheel and which is secured to the inside of the case, where the entire surface of the wheel is exposed to the exterior of the case and the rotary inputting device is capable of inputting information by means of the rotation of the wheel, an optical module secured to the inside of the case which recognizes the movement of the case, and a wire connected to an external device which transfers the information inputted by the rotary inputting device and the information recognized by the optical module to the external device.

The information inputting device according to certain embodiments of the invention may have one or more of the following features. For example, the rotary inputting device may be positioned substantially parallel to the case. Also, there may be side buttons equipped on a side of the case.

The rotary inputting device may include a multi-pole ring type magnet secured to the lower side of the wheel and which rotates simultaneously with the wheel, a detection element which detects the rotation of the magnet, a printed circuit board on which the detection element is mounted, a base to which the printed circuit board is secured thereto, and a holder secured to the base which rotatably supports the wheel.

The wheel may have a plurality of securing protrusions protruding downward, with the printed circuit board having at least one side dome button that are to be pressed by the securing protrusions, while a center key may be formed in the center of the wheel, with a center dome button formed on the printed circuit board that is to be pressed by the pressing of the center key. A curved portion may be formed on one of the wheel and the holder in contact with the wheel, with a groove formed in the other of the wheel and the holder, and an elastic member may be positioned in the groove that is to be caught on the curved portion.

The external device may have a display, and the screen of the display may be such that is moved up or down by the rotation of the wheel. The side dome buttons may be formed of at least one pair arranged to be perpendicular to the longitudinal direction of the case. The external device may have a display, and a click function may be performed when a side dome button is pressed.

The external device may have a display, and a wheel click function may be performed when the center dome button is pressed. The wheel may be such that can be rotated 360 degrees.

A winding device may be equipped inside the case which automatically winds the wire by elastic force, and the case may have a substantially cuboidal shape.

Another aspect of the invention provides an inputting method for an information inputting device, connected to an external device having a display, and having a rotary inputting device having a wheel exposed to the exterior. The method includes moving a pointer to a desired position on the display, and pressing the wheel to perform a click function, where the moving is achieved by means of the movement of the information inputting device and/or the rotation of the wheel.

The pointer may be moved upward or downward according to the rotation direction of the wheel, and the pointer may be configured to move by means of the pressing of a center button of the wheel and the movement of the information inputting device.

An insertion hole may be formed in the case, a USB connector on which an insertion protrusion is formed in correspondence with the insertion hole may be formed at one end of the wire, and the USB connector may be connected to the external device. The cross-section of the insertion protrusion may have the shape of a “T”, the insertion hole may be formed in the front surface of the information inputting device, and a winding device may be equipped inside the case that is configured to automatically wind the wire by elastic force.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view of a mouse, as an example of a conventional inputting device.

FIG. 2 is a perspective view of an information inputting device according to an embodiment of the invention.

FIG. 3 is a perspective view of an information inputting device according to an embodiment of the invention, with the upper case removed.

FIG. 4 is a perspective view of the rear surface of an information inputting device according to an embodiment of the invention.

FIG. 5 is a perspective view of a rotary inputting device used in an information inputting device according to an embodiment of the invention before assembly.

FIG. 6 is a cross-sectional view illustrating the rotary inputting device of FIG. 5 after assembly.

FIG. 7a is a perspective view of a holder having curved portions formed along its outer perimeter, according to another embodiment of the invention.

FIG. 7b is a perspective view of a wheel and a holder having curved portions formed along the inner perimeter of the wheel, according to yet another embodiment of the invention.

FIG. 8a is a perspective view illustrating a USB connector coupled to the case in an information inputting device according to still another embodiment of the invention.

FIG. 8b is a cross-sectional view illustrating the USB connector coupled to the case in FIG. 8a.

FIG. 9 is a perspective view of a USB connector.

FIG. 10a is a perspective view illustrating a USB connector connected to a notebook computer while coupled to an information inputting device.

FIG. 10b is a perspective view illustrating a USB connector connected to a notebook computer while separated from an information inputting device.

### DETAILED DESCRIPTION

The information inputting device and inputting method therefor according to certain embodiments of the invention will be described below in more detail with reference to the accompanying drawings, in which those components are rendered the same reference number that are the same or are in correspondence, regardless of the figure number, and redundant explanations are omitted.

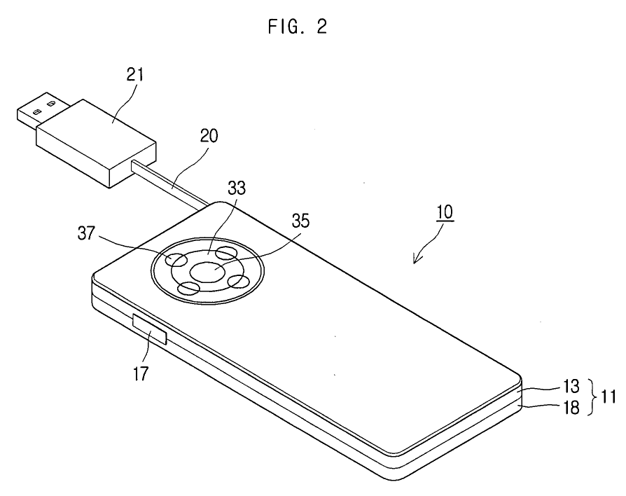

FIG. 2 is a perspective view of an information inputting device 10 according to an embodiment of the invention.

Referring to FIG. 2, an information inputting device 10 according to an embodiment of the invention has a case 11 which has a substantially cuboidal shape and which is composed of an upper case 13 and a lower case 18. Forming the case 11 as a cuboid may allow convenient portability, because when carrying the information inputting device 10, it may readily be inserted in the main body of the notebook computer, etc. The case 11 may be formed to have a small thickness for even more convenient portability. Also, for a more desirable appearance, deco spin processing, etc., may be applied to the upper surface of the upper case 13, etc. The length and width of the case 11 may be formed to allow convenient holding and easy carrying by the user. It is to be appreciated that the shape of the case 11 is obviously not limited to a cuboidal shape, and any shape may be used that allows easy carrying and convenient use.

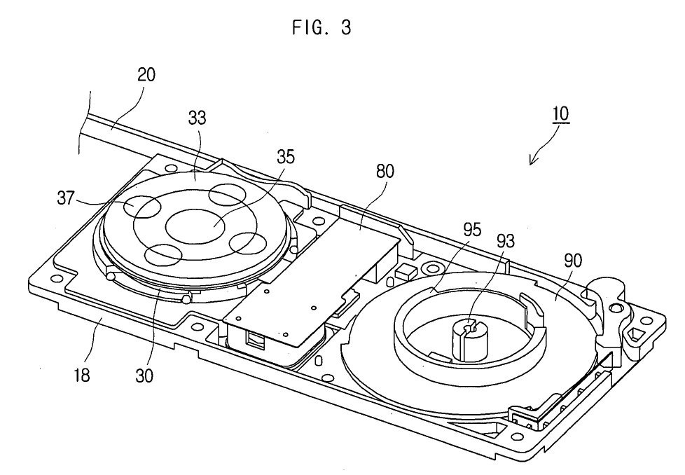

In a portion of the upper case 13, the wheel 33 of a rotary inputting device 30 (see FIG. 3) is exposed to the exterior, where a user may turn the wheel 33 or press the center key 35 formed in the center of the wheel 33 while holding the case 11, using an index finger, etc., to input information. As illustrated in FIG. 3, a rotary inputting device 30, an optical module 80, and a winding device 90 are sequentially coupled to the lower case 18 which couples with the upper case 13 to form an interior space.

At least one side button 17 is formed on the side of the case 11, where the user may press the side button 17 while holding the information inputting device 10, using a thumb, etc., to input information. The functions that may be executed by the side button 17 include, but are not limited to, such functions as a volume control function when an audio function is activated, and a select and run function (i.e. a click function) when the pointer is at a desired position on the display.

A wire 20 is equipped at the front of the case 11 that connects an information inputting device 10 according to an embodiment of the invention with an external device (not shown). The wire 20, as illustrated in FIG. 3, is automatically wound by a winding device 90. That is, the wire 20 is unwound by the user to extend to the exterior, and while being carried, may be wound automatically with a slight pull by the hand, by means of the elastic force of a spiral spring mounted inside the winding device 90. Signals generated by the rotary inputting device 30 and optical module 80 formed inside the information inputting device 10 are transferred through the wire 20 to the external device (not shown). A terminal 21 on the end of the wire 20 couples with the external device.

FIG. 3 is a perspective view in which the upper case 13 is removed, to show the internal structure of an information inputting device 10 according to an embodiment of the invention. Referring to FIG. 3, a rotary inputting device 30, an optical module 80, and a winding device 90 are sequentially coupled to the lower case 18. For convenience in explanation, the specific composition inside the winding device 90 has not been illustrated.

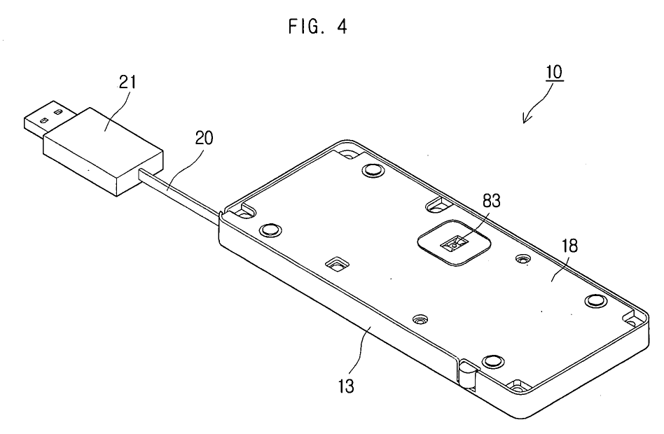

The optical module 80 recognizes the movement of the information inputting device 10, and then transfers this information through the wire 20 to the external device. The optical module 80, as illustrated in FIG. 4, emits a light source such as an LED through a lens 83, and a sensor recognizes the reflected light to move the pointer to a desired position on the display. A module having a small volume may advantageously be used for the optical module 80 to reduce the overall volume of the information inputting device 10. The specific composition and operation method of the optical module 80 are of common knowledge in the relevant field of art, and thus detailed descriptions will not be provided on this matter.

The winding device 90 secured to the inside of the case 11 winds the wire 20. In the winding device 90, a spiral spring (not shown) is secured to the support protrusion 93, as described above, to provide a rotational force to a rotary bobbin 95. The wire 20 is automatically wound around the rotary bobbin 95. That is, while the wire 20 is pulled out by hand by the user when it is extracted from the inside of the case 11, when the wire 20 is to be wound up, it is pulled slightly, at which the rotary bobbin 95 is made to rotate by the elastic force of the spiral spring and the wire 20 is wound automatically. The winding device 90 may be mounted substantially parallel to the case 11, so that the thickness of the information inputting device 10 may be reduced. The specific composition of the winding device 90 is of common knowledge in the relevant field of art, and thus detailed descriptions will not be provided on this matter.

The rotary inputting device 30 is secured to be substantially parallel to the case 11, with the wheel 33 exposed to the exterior of the upper case 13. By rotating the wheel 33 of the rotary inputting device 30, a user may perform the function of the wheel mounted perpendicularly in the conventional mouse, etc. Whereas the conventional mouse wheel was mounted perpendicularly such that the volume of the mouse was increased, the rotary inputting device 30 according to this embodiment is mounted substantially horizontally, so that the volume may be reduced. In this embodiment, the wheel 33 may be rotated clockwise or counterclockwise to move the screen of the display up or down.

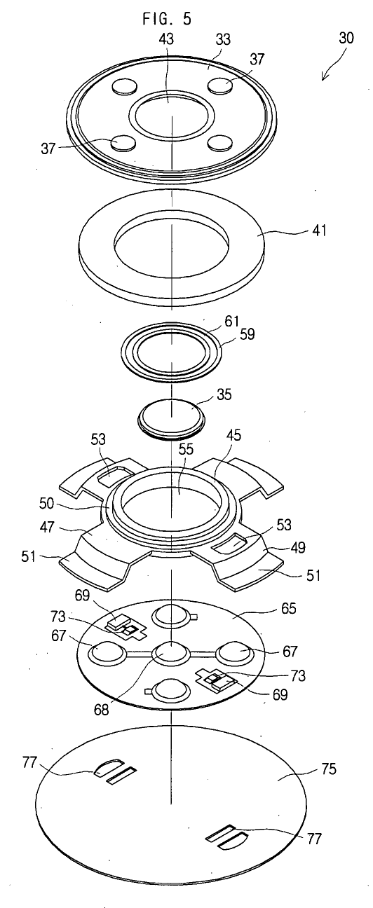

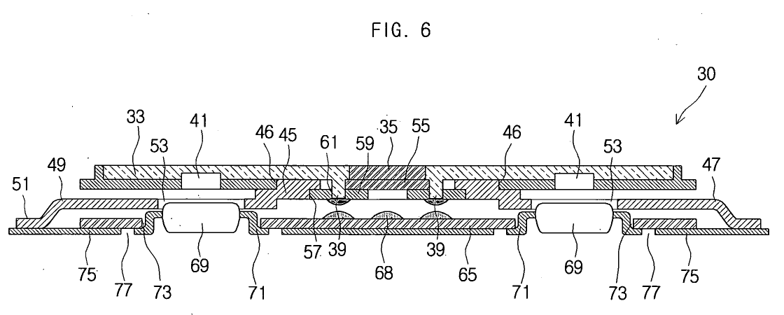

FIG. 5 is an exploded perspective view of a rotary inputting device 30 according to an embodiment of the invention, and FIG. 6 is a cross-sectional view of the rotary inputting device after assembly.

Referring to FIGS. 5 and 6, the rotary inputting device 30 according to this embodiment includes a rotatably coupled wheel 33, a washer 59 that secures the wheel 33 to the holder, a center key 35 coupled to the center of the wheel 33, a ring-shaped magnet 41 that is secured to the lower side of the wheel 33 to be rotated together with the wheel 33, a holder 45 coupled to the upper surface of the base 75 to rotatably support the wheel 33, a printed circuit board 65 secured to the upper surface of the base 75, and Hall sensors 69 positioned on the printed circuit board 65, which are detection elements that sense the rotation of the magnet 41.

The wheel 33 is generally shaped as a circular plate, with an insertion hole 43 formed in the center through which the center key 35 may be inserted. The wheel 33 has a plurality of securing protrusions 39 adjacent to the insertion hole 43 that protrude downwards. As the securing protrusions 39 are inserted into the rotation hole 61 of the washer 59, the wheel 33 is rotatably secured to the holder 45. On the lower surface of the wheel 33 is secured the magnet 41, which is magnetized to have multiple poles. The wheel 33 is rotated together with the magnet 41 by user operation, whereby a variety of inputs may be made as the Hall sensors 69 sense the rotation angle, direction, and speed, etc., of the magnet 41. Also, a portion may be pressed by the user, so that a securing protrusion 39 formed on the reverse side of the holder 45 presses a side dome button 67 or a center dome button 68 to input information.

The securing protrusions 39, as illustrated in FIG. 6, are inserted through the center hole 55 of the holder 45 and the rotation hole 61 of the washer 59, with the ends processed such that they are not detached from the rotation hole 61. The washer 59 is inserted and secured onto the center of the holder 45, whereby the wheel 33 is secured to the holder 45. Since the rotation hole 61 of the washer 59, in which the securing protrusions 39 are inserted, is formed over the entire circumference of the washer 59, the wheel 33 is able to rotate 360 degrees.

The magnet 41 is attached to the lower surface of the wheel 33 to be rotated together with the wheel 33, and such rotation of the magnet 41 is sensed by the Hall sensors 69 for an input based on the rotation angle. The magnet 41 has the shape of a ring magnetized to have alternating N- and S-poles, and the Hall sensors 69 are able to detect the rotation angle, direction, and speed of the wheel 33 according to the changes in N- and S-poles above the Hall sensors 69.

The holder 45 is secured to one side of the base 75 and rotatably supports the wheel 33. The holder 45 may be made of metal, such as stainless steel, etc., so that when the particular force applied on the wheel 33 is removed, the wheel 33 is returned to its original position due to the elasticity of the holder 45 itself. The holder 45 may be formed by press processing, etc. Of course, the holder 45 may also be formed by plastics, etc., that are high in elasticity.

The holder 45 includes a ring-shaped body portion 50, and a support portion 47 protruding from the perimeter of the body portion 50 and secured to a side of the base 75. The body portion 50 has a center hole 55 in the middle, and the support portion 47 protruding in four directions around the center hole 55 includes an inclination portion 49 protruding downwards in a particular inclination, and a securing portion 51 extending horizontally from the end of the inclination portion 49.

The inclination portion 49 protrudes outwards and connects the body portion 50 and the securing portion 51. Since the inclination portion 49 is formed by metal, etc., having elasticity, when an external force applied on the holder 45 is removed, the holder 45 is returned to its original position by means of the elasticity of the inclination portion 49. Thus, even when a particular portion of the wheel 33 is pressed so that the wheel 33 becomes tilted, this elasticity allows it to be restored to its original position. The securing portion 51 extends from the end of the inclination portion 49 and is secured to the upper surface of the base 75 to secure the holder 45. The securing portion 51 may be secured to the base 75 by means of adhesive or double-sided tape, etc.

Since the holder 45 is secured directly to a side of the base 75 by means of adhesive, etc., the rotary inputting device according to this embodiment shows superb endurance to external impact. Also, the elasticity of the holder 45, which is formed of metal, allows not only the holder 45 itself but also the wheel 33 to be restored to their original positions, to provide a better tactile feel.

In the support portion 47 are formed support portion holes 53. As illustrated in FIG. 6, portions of the Hall sensors 69, i.e. the sensing means, may be positioned in the support portion holes 53. Also, the body portion 50 has a stepped edge 57 formed adjacent to the center hole 55.

The support portion holes 53 in the support portion 47 are formed to correspond with the Hall sensors 69 mounted on the printed circuit board 65, and as illustrated in FIG. 6, hold portions of the Hall sensors 69. The center hole 55 is formed in the center of the holder 45. The stepped edge 57, as illustrated in FIG. 6, are formed adjacent to the center hole 55. The washer 59 is inserted and secured onto the stepped edge 57.

As illustrated in FIG. 5, the washer 59 is generally shaped as a donut, with a rotation hole 61 formed along the circumference. The washer 59 is inserted and secured onto the stepped edge 57 to prevent the wheel 33 from becoming detached. The center key 35 is inserted through the insertion hole 43 of the wheel 33 and is supported by elastic rubber (not shown), etc.

The printed circuit board 65 has the shape of a circular plate in correspondence with the base 75, with a center dome button 68 and a plurality of side dome buttons 67 formed on one side in correspondence with the securing protrusions 39. The printed circuit board 65 is formed with a diameter somewhat shorter than the diameter of the base 75, in order to allow a sufficient area where the securing portion 51 of the holder 45 may be secured.

The center dome button 68 may be pressed by the center key 35, and the side dome buttons 67 may be pressed by the securing protrusions 39, to input information. Pressing the side dome button 67 may perform a click function such as in the conventional mouse, while pressing the center dome button 68 may perform a wheel click function. While in this embodiment dome buttons are illustrated that are pressed by the wheel 33, the invention is not thus limited. Instead of the dome buttons, pressure sensors or contact sensors, for example, may also be used.

Receiving holes 73 are formed in the printed circuit board 65 in correspondence with the support portion holes 53 of the holder 45, and as illustrated in FIG. 6, at least portions of the Hall sensors 69 may be positioned in the receiving holes 73. Thus, compared to the case of mounting the Hall sensors 69 on the upper surface of the printed circuit board 65, the thickness of the inputting device in the present embodiment may be reduced by the depth of a receiving hole 73.

The detection element may be a Hall sensor (Hall effect sensor), which is a silicon semiconductor using the effect of electromotive forces generated when electrons experience the Lorentz force in a magnetic field and their direction is curved. The Hall sensors generate electromotive forces that are proportional to the rotation of the magnet 41 attached to the wheel 33, which are transferred via the printed circuit board 65 to an external control device (not shown).

Of course, the detection element is not limited to a Hall sensor, and any element may be used which is able to detect the rotation of the magnet 41. For example, an MR (magneto-resistive) sensor or a GMR (giant magneto-resistive) sensor may be used for the detection element. An MR sensor or a GMR sensor is an element of which the resistance value is changed according to changes in the magnetic field, and utilizes the property that electromagnetic forces curve and elongate the carrier path in a solid to change the resistance. Not only are MR sensors or GMR sensors small in size with high signal levels, but also they have excellent sensitivity to allow operation in low-level magnetic fields, and they are also superb in terms of temperature stability.

When the detection elements are Hall sensors 69, the Hall sensors 69 are secured to the printed circuit board 65 by leads 71, where the leads 71 are inserted through the insertion holes 77 of the base 75 and secured to the reverse side of the printed circuit board 65.

The base 75, as illustrated in FIG. 5, has the shape of a circular plate, and rotatably supports the holder 45 and the wheel 33. The diameter of the base 75 is formed to be somewhat longer than that of the printed circuit board 65. Also, insertion holes 77 are formed on the base 75 in correspondence with the receiving holes 73 of the printed circuit board 65. Portions of the Hall sensors 69 are positioned in the insertion holes 77, whereby the thickness of the rotary inputting device may further be reduced by the depth of the insertion holes 77.

Although the present embodiment uses the detection elements, such as the magnet and the Hall sensors, to detect the rotation of the wheel, it shall be evident that various methods, such as, but not limited to, using image processing and detecting variable resistance or change in capacitance, in the rotary inputting device 300.

In the method of using image processing, marks indicating brightness are alternately adhered to the reverse side of the wheel 33. While the reverse side of the wheel 33 is irradiated with an LED, an image sensor detects the rotation of the marks, caused by the rotation of the wheel 33, to enable the input of information.

In the method of using variable resistance, a conductive material and a non-conductive material are alternately arranged on the outer perimeter 46. When the wheel 33 makes a contact with the conductive material and the non-conductive material, the difference in strength of electric current is detected to enable the input of information. The method of using the change in capacitance detects the change in capacitance of a capacitor, which is located on the reverse side of the wheel 33, when a finger or a writing utensil of a user makes a contact with the upper surface of the wheel 33 and rotates along the wheel 33. When the capacitance is used as described above, the wheel 33 itself does not rotate.

A description will be provided below on the operation of the rotary inputting device according to this embodiment.

When a rotational force is applied by a user on an outer side of the center key 35, the wheel 33 is rotated while positioned on the perimeter 46 of the holder 45, which causes the magnet 41 to also rotate together with the wheel 33. As the magnet 41 has a multiple number of alternately magnetized N- and S-poles, the Hall sensors 69 can sense the changes in poles due to the rotation of the magnet 41, to identify the rotation direction, speed, and angle of the wheel 33. The Hall sensors 69 generate output signals corresponding to the rotation direction, rotation angle, and rotation speed of the wheel 33, which are transmitted via the printed circuit board 65 to an external control device, and the control device recognizes the output signals to perform an input corresponding to the rotation of the wheel 33.

Also, when an outer side of the wheel 33 is pressed by a user, it is tilted in one direction while elastically supported by the holder 45, which causes a push protrusion (not shown) formed on the reverse side of the holder 45 to press a side dome button 67. The center key 35 may also perform a separate function when pressed by a user. This allows each of the center dome button 68 and side dome buttons 67 positioned on the printed circuit board 65 to perform its own function.

As discussed above, an information inputting device 10 according to this embodiment uses a rotary inputting device 30 having a small thickness, so that the overall volume and thickness may be reduced, for easier carriage and storage. The rotary inputting device 30 is positioned to be substantially horizontal with respect to the case 11.

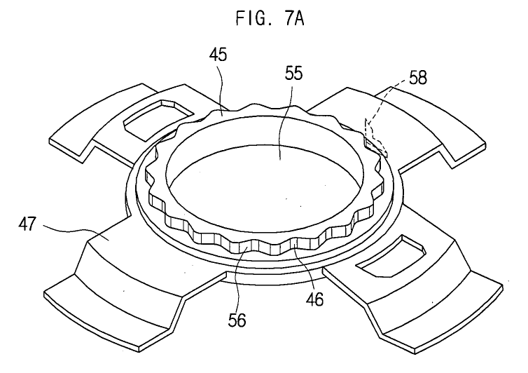

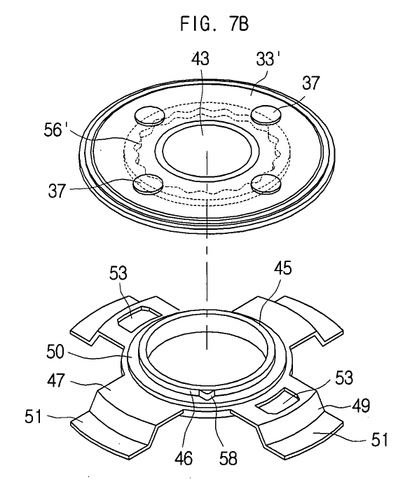

FIG. 7a is a perspective view of a holder 45 according to another embodiment of the invention.

Referring to FIG. 7, the holder 45 according to this embodiment has curved portions 56 formed along the outer perimeter of the center hole 55. Also, on the inner perimeter of the wheel 33 facing the curved portions 56 are formed grooves (not shown), in which an elastic member 58 (shown in dotted lines) may be formed. When the wheel 33 is rotated, the elastic member 58 inserted in the groove withdraws to the inside of the groove when pressed by the concave part of the curved portions 56, and protrudes to the outside of the groove when met with the convex part of the curved portions 56. Thus, when the wheel 33 is rotated, a rotating sensation is transferred to the user by the interaction between the curved portions 56 and the elastic member 58, for a better tactile feel.

FIG. 7b is a perspective view of a wheel 33′ and a holder 45 having curved portions 56′ formed along the inner perimeter of the wheel 33.

As illustrated in FIG. 7b, the curved portions 56′ may also be formed on the inner perimeter of the wheel 33′, in which case the elastic member 58 protrudes from the outer perimeter 46 of the holder 45. Thus, when the wheel 33′ is rotated after inserted onto the holder 45, a certain clicking sensation is created by the interaction between the curved portions 56′ and the elastic member 58.

A description will be provided below on the method of inputting information for the information inputting device according to this embodiment. The information inputting device according to this embodiment is connected to an external apparatus having a display. On the display is shown a pointer (hereinafter referred to as “pointer”), such as a cursor, a highlighted indicator on a menu list, and an arrow shape, etc.

To move the pointer to a desired position on the display, the user uses the methods of moving the information inputting device 10 as well as rotating the wheel 33. When the information inputting device 10 is moved, the pointer is moved 2-dimensionally on the display to a positioned desired by the user. When the wheel 33 is rotated, the display on which the pointer is positioned is moved up or down overall. A clockwise rotation of the wheel 33 may move the display upwards and a counterclockwise rotation may move it downward, or vice versa.

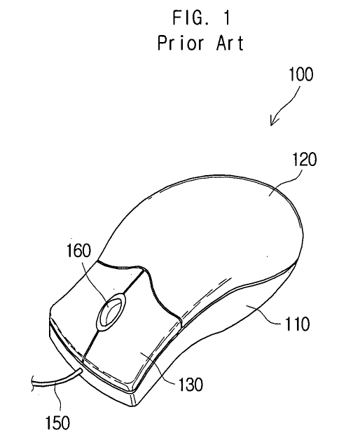

In the information inputting method according to this embodiment, the wheel 33 is able to rotate 360 degrees, whereby the screen may be moved up or down continuously, without having to remove the finger from the wheel 33. With the wheel 60 (FIG. 1) of a conventional inputting device such as a mouse, only a portion is exposed to the exterior, so that there is a limit to the rotation angle by which the wheel can be moved by a single maneuver. However, with the information inputting method of this embodiment, the entire surface of the wheel 33 is exposed to the exterior for 360-degree rotation, which allows convenience in use, as the screen can be moved up or down continuously with a single maneuver.

Another method for moving the pointer to a desired position on the display is to move the information inputting device 10 up or down after pressing the center key 35. When the center key 35 is pressed, arrows of the up-down and left-right directions are shown on the display, at which moving the information inputting device 10 in the up-down and left-right directions causes the screen on the display to move to the extremity in the up-down and/or left-right directions.

After the pointer is moved to a desired position on the display, the user presses the side key 37 on the rotary information inputting device 30 to execute a menu item or link, etc., selected by the pointer. For example, pressing the left side key 37 may execute a menu item or link, etc., selected by the pointer, while pressing the right side key 37 may prompt another menu list shown on the display. The menu item or link, etc., selected by the pointer may also be executed using the side buttons 17 formed on the side of the information inputting device 10.

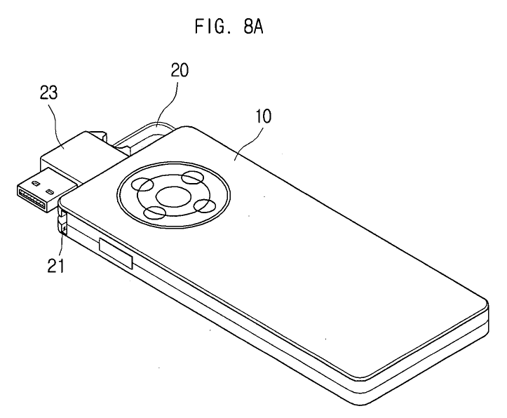

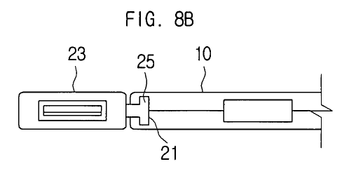

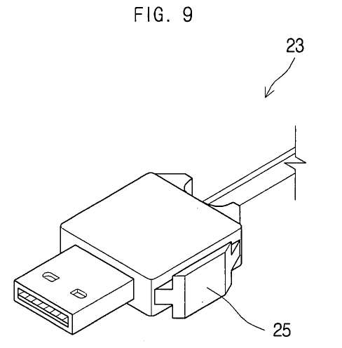

FIG. 8a is a perspective view illustrating a USB connector coupled to the information inputting device according to another embodiment of the invention, and FIG. 8b is a cross-sectional view illustrating the USB connector coupled to the information inputting device in FIG. 8a. FIG. 9 is a perspective view of a USB connector.

Referring to FIGS. 8a to 8b and FIG. 9, a USB connector 23 that can be coupled to the USB terminal (not shown) of the external device is equipped on the end of the wire 20 of the information inputting device 10. An insertion protrusion 25 having a cross section shaped as a letter “T” is formed on the side of the USB connector 23, while a matching insertion groove 21 is formed in the front surface of the information inputting device 10. Thus, by means of the coupling between the insertion protrusion 25 and the insertion groove 21, the USB connector 23 may be secured to the information inputting device 10, and as a matter of course, the USB connector 23 may be separated from the information inputting device 10.

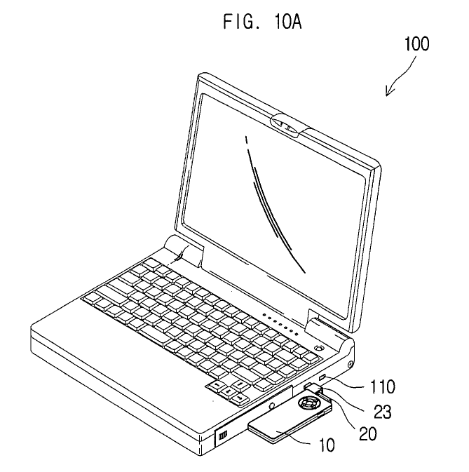

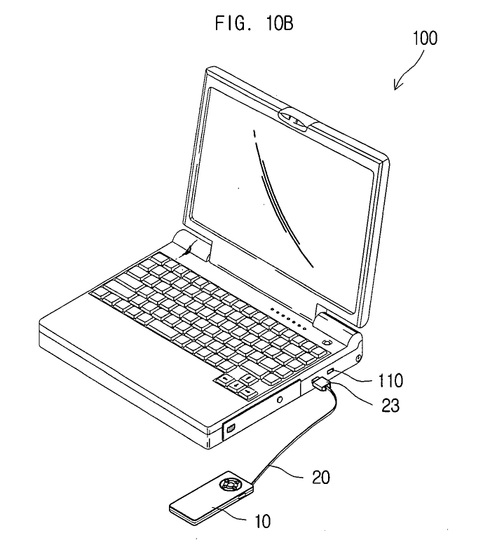

One end of the wire 20 is connected with the USB connector 23, while the other end is wound by the winding device equipped inside the case. Thus, when it is desired that the USB connector 23 be extended out for use, the USB connector 23 may be separated from the information inputting device 10 and the wire 20 pulled, as illustrated in FIG. 10b. Also, when storing the information inputting device, or as illustrated in FIG. 10a, when using the information inputting device 10 next to an external apparatus such as a notebook computer 100, the wire may be pulled slightly so that it is wound by the winding device, after which the USB connector 23 may be coupled to the information inputting device 10, and the USB connector 23 may be inserted into the notebook computer 100.

As such, with the information inputting device according to this embodiment, not only may the wire 20 be readily organized and used with the length freely adjusted, but also the information inputting device 10 may be used adjacent to a notebook computer 100, as illustrated in FIG. 10a. In FIG. 10a, the coupling direction of the USB connector 23 and the longitudinal direction of the information inputting device 10 are substantially perpendicular, for greater convenience in use.

According to certain embodiments of the invention as set forth above, an information inputting device and inputting method therefor may be provided, where the information inputting device has a small volume for convenient use and portability.

Also, an information inputting device and inputting method therefor may be provided that allow convenient use, as the wire of the information inputting device is wound automatically.

Further, an information inputting device and inputting method therefor may be provided that allow a better tactile feel, as a consistent clicking sensation is created when the wheel is rotated.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. An information inputting device comprising:
a case;
a rotary inputting device having a rotatable wheel and secured to the inside of the case, wherein the entire surface of the wheel is exposed to the exterior of the case and the rotary inputting device is capable of inputting information by means of the rotation of the wheel;
an optical module secured to the inside of the case and configured to recognize the movement of the case; and
a wire connected to an external device and configured to transfer information inputted by the rotary inputting device and information recognized by the optical module to the external device.

2. The information inputting device of claim 1, wherein the rotary inputting device is positioned substantially parallel to the case.

3. The information inputting device of claim 1, having at least one side button on at least one side of the case.

4. The information inputting device of claim 1, wherein the rotary inputting device comprises:
a multi-pole ring type magnet secured to the lower side of the wheel and configured to rotate simultaneously with the wheel;
a detection element configured to detect the rotation of the magnet;
a printed circuit board having the detection element mounted thereon;
a base having the printed circuit board secured thereto; and
a holder secured to the base and configured to rotatably support the wheel.

5. The information inputting device of claim 4, wherein the wheel has a plurality of securing protrusions protruding downward, and
the printed circuit board has at least one side dome button configured to be pressed by the securing protrusions.

6. The information inputting device of claim 4, wherein a center key is formed in the center of the wheel, and
a center dome button is formed on the printed circuit board, the center dome button configured to be pressed by the pressing of the center key.

7. The information inputting device of claim 4, wherein a curved portion is formed on one of the wheel and the holder in contact with the wheel,
a groove is formed in the other of the wheel and the holder, and
an elastic member is positioned in the groove, the elastic member configured to be caught on the curved portion.

8. The information inputting device of claim 1, wherein the external device has a display, and
the screen of the display is moved up or down by the rotation of the wheel.

9. The information inputting device of claim 5, wherein the at least one side dome button is formed of at least one pair arranged to be perpendicular to the longitudinal direction of the case.

10. The information inputting device of claim 9, wherein the external device has a display, and
a click function is performed when the at least one side dome button is pressed.

11. The information inputting device of claim 6, wherein the external device has a display, and
a wheel click function is performed when the center dome button is pressed.

12. The information inputting device of claim 1, wherein the wheel is rotatable in 360 degrees.

13. The information inputting device of claim 1, having a winding device inside the case, the winding device configured to automatically wind the wire by elastic force.

14. The information inputting device of claim 1, wherein the case has a substantially cuboidal shape.

15. The information inputting device of claim 1, wherein an insertion hole is formed in the case,
a USB connector having an insertion protrusion formed thereon in correspondence with the insertion hole is formed at one end of the wire, and
the USB connector is connected to the external device.

16. The information inputting device of claim 15, wherein the cross-section of the insertion protrusion has the shape of a “T”, and
the insertion hole is formed in the front surface of the information inputting device.

17. The information inputting device of claim 15, having a winding device inside the case, the winding device configured to automatically wind the wire by elastic force.

18. The information inputting device of claim 1, in which a plurality of marks are adhered to a reverse side of the wheel, and
the information inputting device further comprises a light emitting diode, irradiating the marks, and an image sensor, detecting a movement of the marks if the marks are rotated by a rotation of the wheel.

19. The information inputting device of claim 1, in which the information inputting device alternately makes contact with a conductive material and a non-conductive material when the wheel rotates, and information is inputted by recognizing a difference in strength of electric current between when the wheel makes contact with the conductive material and when the wheel makes contact with the non-conductive material.

20. An information inputting device comprising:
a case;
a rotary inputting device having a rotatable wheel and secured to the inside of the case, wherein the entire surface of the wheel is exposed to the exterior of the case and the rotary inputting device is capable of inputting information by means of the rotation of the wheel;
an optical module secured to the inside of the case and configured to recognize the movement of the case; and
a wire connected to an external device and configured to transfer information inputted by the rotary inputting device and information recognized by the optical module to the external device.

21. An inputting method for an information inputting device, connected to an external device having a display, and having a rotary inputting device having a wheel exposed to the exterior, the method comprising:
moving a pointer to a desired position on the display; and
pressing the wheel to perform a click function,
wherein the moving is achieved by means of the movement of the information inputting device and/or the rotation of the wheel.

22. The method of claim 21, wherein the pointer is moved upward or downward according to the rotation direction of the wheel.

23. The method of claim 21, wherein the pointer is configured to move by means of the pressing of a center button of the wheel and the movement of the information inputting device.
